(19) United States
(12) Patent Application Publication
(10) Pub. No.: US 2008/0042877 A1
(43) Pub. Date: Feb. 21, 2008

(54) Integrated Traffic Management System

(76) Inventor: Roger H. Kennedy, Manchester (GB)

Correspondence Address: CASELLA & HESPOS, 274 MADISON AVENUE, NEW YORK, NY, 10016, US

(21) Appl. No.: 11/793,130

(22) PCT Filed: Dec. 14, 2004
(86) PCT No.: PCT/GB04/05242

§ 371 Date: Jun. 13, 2007

(51) Int. Cl. G07B 15/00; G08G 1/01

(52) U.S. Cl. 340/936; 340/937

(57) ABSTRACT

An integrated traffic management system comprising a parking meter arrangement that monitors traffic violations.

This invention relates to traffic management systems.

A major requirement in times when increasing vehicle numbers are causing traffic congestion in urban areas is to make best use of road space and ensure traffic proceeds in orderly fashion.

Solutions, at best partial, have been ad hoc and piecemeal.

It is now perceived that a comprehensive traffic management system is long overdue, but no satisfactory system has yet been proposed.

The present invention provides at least the basis for a comprehensive system that can be augmented to include various options for traffic management and security on city streets.

The invention comprises an integrated traffic management system comprising a parking meter arrangement that monitors traffic violations.

The parking meter may be associated with at least one digital camera, which may monitor parking violations. The expiry of an allotted parking time may trigger the camera to image a vehicle for identification and associate the image with data about the violation.

The camera may capture an image of a conventional number plate as the vehicle is driven away after a violation. Or a municipality may issue identification tabs for display on vehicles that permit parking when in the camera's view—tabless parking would itself constitute a violation.

At least one camera may be a moving traffic offence detecting camera. At least one camera may be a security surveillance camera imaging vehicles and other property—in this way, a municipal authority can offer the motorist a degree of security for his parked vehicle in further consideration for parking fees.

Said moving traffic offence or security surveillance camera may be patched through to a monitoring station on a polled basis, and/or may be triggered by detection of a moving traffic or security violation or other event. A camera may, for example, have associated software that identifies potentially criminal activity, or there may be a glass-break detector.

The parking meter may have communication facility direct to traffic wardens and/or police or other security services, and/or to a central control arrangement. The meter may also be adapted for communication with another parking meter or meters and/or other security surveillance arrangements.

The meter may have a facility to accept credit card payment for parking and/or penalties and selected meters may collect tolls electronically as part of a pay-by-use scheme, even if a passing vehicle is not parked.

An example of an integrated traffic management system in accordance with the invention will now be described with reference to the accompanying drawing, in which:

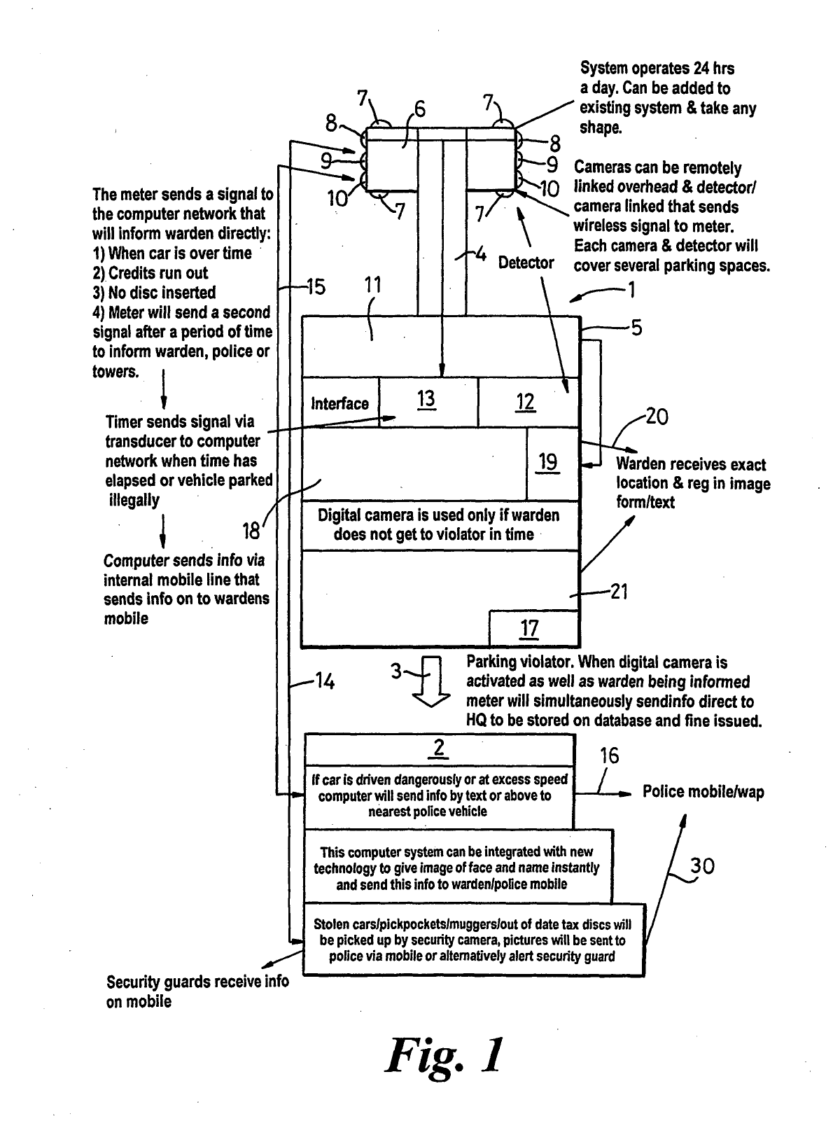

FIG. 1 shows a schematic block diagram of an integrated traffic management system.

FIG. 1 shows a parking meter 1 that is connected to a central computer 2 via a communication link 3. The communication link 3 may be a wired link, such as a landline, or a wireless communication link, such as a mobile telephone communication link or a satellite communication link.

The parking meter 1 includes a main housing 5 from which extends a post 4. On the top of the post 4 is mounted a turret arrangement 6. Mounted on the turret arrangement 6 are sonar detectors 7, digital parking cameras 8, digital security cameras 9 and digital speed cameras 10. The sonar detectors 7 monitor the arrival of vehicles at a parking bay and send signals to a processor 11 within the main housing 5 to register time of arrival and departure of the vehicle and the time spent by the vehicle in the parking bay. The processor 11 processes all incoming and outgoing signals and calculates elapsed time and registers time of arrivals and departures of a vehicle at a parking bay. Other internal electronics within the housing include transducer instrumentation 12 for receiving signals from the sonar detectors 7 prior to passing the signals to the processor 11 and a timer and transducer 13 linked to the digital parking cameras 8, which receives signals from the parking cameras 8 before passing them to the processor 11. The timer and transducer 13 also receives an input from the digital speed cameras 10 and then also passes this input to the processor 11.

Images from the digital security cameras 9 are passed directly to the central computer 2. The images from the digital security cameras 9 can be used to identify, for example, stolen cars, identify criminals, such as pick-pockets or muggers or to identify out of date tax discs. The images can be forwarded to police or other security services via radio or any other suitable wireless communication 30, such as a mobile phone service. Typically, the communication link between the digital security cameras 9 and the central computer 2 is via a wireless link 14. Images from the digital speed cameras 10 are sent via wireless link 15 to the timer and transducer 13 and to the central computer 2. If the images from the speed cameras 10 when processed by the central computer 2 indicate that a car is driven dangerously or at excessive speed the computer 2 sends relevant information by text and/or image to the nearest police vehicle, such as by radio or any other suitable wireless connections 16. The detectors 7 and the cameras 8, 9 and 10 can send output signals to the processing electronics within the housing 5 via a wired communication link and/or a wireless link. In addition, it is also possible that the signals could be sent via a wired or a wireless link to the central computer 2.

The housing 5 also includes a mechanism to permit a user of a vehicle parking in a parking bay to pay for the parking by including coin and/or bank note receiving mechanisms and a credit card receiving mechanism 17 to permit payment by suitable bank cards, such as credit cards or charge cards.

If the processor 11 detects that a vehicle is parked in a parking bay and time paid for or allocated to that vehicle has run out, or no payment has been made, an image of that vehicle can be processed 18 by the internal electronics and sent direct to a traffic warden or other security service via a wireless transmitter 19 which establishes a wireless communication link 20 with the traffic warden or other security service and the processor 11 transmits information relating to the vehicle location and an identification of the vehicle, such as the registration number. The information may be transmitted in text and/or image format.

Alternatively, when a parking violation is detected the relevant information can be sent 21 directly to central computer 2 via communication link 3 and the central computer 2 can then process the violation and automatically issue a fine to the registered keeper of the vehicle. However, it is possible that the information may only be sent to the central computer 2 if the vehicle leaves the parking bay before a traffic warden arrives.

The turret 6 may be fixed. However, it is also possible that the turret 6 may rotate on the post 4 and/or that the post 4 may move up and down to raise and lower the turret 6, as necessary.

1. An integrated traffic management system comprising a parking meter arrangement that monitors traffic violations.

2. A system according to claim 1, in which a parking meter is associated with at least one digital camera.

3. A system according to claim 2, in which said camera monitor parking violations.

4. A system according to claim 3, in which the expiry of an allotted parking time triggers the camera to image a vehicle for identification and associates the image with data about the violation.

5. A system according to claims 1, in which at least one camera is a moving traffic offence detecting camera.

6. A system according to claims 5, in which at least one camera is a security surveillance camera imaging vehicles and other property.

7. A system according to claim 5, in which the said camera is patched through to a monitoring station on a polled basis.

8. A system according to claims 5, in which the said camera is triggered by detection of a moving traffic or security violation.

9. A system according to claim 8, in which said camera is triggered by detection of excessive vehicle speed or traffic light violation.

10. A system according to claims 1, in which the parking meter has communication facility direct to traffic wardens, police or other security services.

11. A system according to of claims 1, in which the parking meter has communication facility to a central control arrangement.

12. A system according to claims 1, in which the parking meter is adapted for communication with at least one other parking meter or other security surveillance arrangements.

13. A system according to claims 1, having facility to accept credit card payment for parking or penalties.

14. (canceled)

15. A system according to claim 6, in which the said camera is patched through to a monitoring station on a polled basis.

16. A system according to claim 6, in which the said camera is triggered by detection of a moving traffic or security violation.

17. A system according to claim 16, in which said camera is triggered by detection of excessive vehicle speed or traffic light violation.
